(19) United States
(12) Patent Application Publication
(10) Pub. No.: US 2008/0033623 A1
(43) Pub. Date: Feb. 7, 2008

(54) Method For The Predictive Determination Of The Change In The Yaw Rate Of A Vehicle

(75) Inventors: Ottmar Gehring, Kernen (DE); Harro Heilmann, Ostfildern (DE); Sascha Paasche, Tokyo (JP); Andreas Schwarzhaupt, Landau (DE); Gernot Spiegelberg, Bad Abbach (DE); Armin Sulzmann, Heidelberg (DE)

Correspondence Address: FITCH, EVEN, TABIN & FLANNERY, P. O. BOX 18415, WASHINGTON, DC, 20036, US

(73) Assignee: DaimlerChrysler, Stuttgart (DE)

(21) Appl. No.: 11/628,537

(22) PCT Filed: Jun. 2, 2005
(86) PCT No.: PCT/EP05/05919

§ 371 Date: May 8, 2007

(30) Foreign Application Priority Data
Jun. 5, 2004 (DE) 102004027587.4

(51) Int. Cl. B60T 8/1755

(52) U.S. Cl. 701/83; 303/146

(57) ABSTRACT

The invention relates to a method for the predictive determination of the change in the yaw rate (ψ) of a vehicle. According to said method, the progress of the build-up of the braking pressures (p₁ to p₄) of the wheel brakes is monitored, and the change in the yaw rate (ψ) of the vehicle is determined in a predictive manner from the progress of the pressure build-up before the vehicle rotates around the vertical axis thereof. The inventive method allows the driving stability of a vehicle to be better regulated.

The invention relates to a method for the predictive determination of the change in the yaw rate of a vehicle and a system for stabilizing the movement dynamics of a vehicle, said system comprising a device for determining set variables for an intervention in the vehicle movement dynamics.

Known systems for stabilizing the movement dynamics (ESP) of a vehicle react to instabilities of the vehicle by measuring the state variables, for example the lateral acceleration, the steering angle, and the like. As a result of this purely reactive behavior, the vehicle can be stabilized only after the instability has already occurred, because only then can the sensors measure the vehicle reaction. Especially for utility vehicles, this can lead to driving conditions that are difficult to control since rotational energy has already built up in the vehicle around the vertical axis. In many cases, a utility vehicle becomes unstable when the brakes of an anti-lock braking (ABS) system are applied on a driving surface with uneven frictional coefficient (and turned steering wheel) because uneven braking pressures build up at the wheels.

A method for regulating the driving stability of a vehicle is known from document DE 101 03 629 A1, for which a vehicle slip angle speed is determined in dependence on input variables, and this slip angle speed is then taken into consideration for computing the pressures for the individual brakes of the vehicle, so that the driving stability is increased through an intervention at the individual brake for each wheel. A high dynamic toe change situation is determined by analyzing variables, which reflect the desired and actual driving behavior of the vehicle and a regulation situation. An intervention at the brakes is then realized in dependence on the analysis results, which reduces the slip angle. However, this system also operates only in a reactive manner.

Document DE 42 29 504 A1 discloses a method for regulating the vehicle stability by determining the yaw speed and then comparing it to a reference yaw speed. The deviation is used to adjust a counter moment for the yaw with the aid of a regulator if the yaw speed is too high. In the process, the vehicle not only reacts to specified steering angles, as set by the driver, but also maintains a stable state that depends on the frictional coefficient of the road and for which the slip angle does not increase further.

It is therefore the object of the present invention to create an option for reacting to the change in the yaw rate before this change occurs.

This object is solved according to the invention with a method of the aforementioned type, for which the pressure build-up progress for the braking pressures of the wheel brakes is monitored and for which the change in the yaw rate is determined predictive from the progress of the pressure build-up before the vehicle rotates around its vertical axis. It means that a change in the yaw rate of the vehicle can already be estimated before it occurs. With the aid of the estimation and/or predictive determination of the change in the yaw rate, a system for stabilizing the vehicle movement dynamics, particularly an ESP system with steering intervention, can already prevent the undesirable rotation of the vehicle around its vertical axis during the interval prior to the vehicle reaction. As a result of this measure, instabilities in vehicles can be prevented, especially in utility vehicles, by initially making a predictive determination of the yaw rate for the vehicle and by subsequently determining the expected change in the yaw rate from this. It is particularly advantageous that the progress of the pressure build-up for the braking pressures of the wheel brakes is already monitored in the ABS system. These data can be used to determine the expected yaw rate and/or the upcoming change in the yaw rate.

It is especially advantageous that this change in the yaw rate can be used to determine an intervention in the vehicle movement dynamics, so as to prevent an undesirable rotation.

The determination of the change in the yaw rate can be further improved by detecting and taking into account additional state variables for the vehicle in order to compute the change in the yaw rate. Considered as additional state variables are in particular the adjusted steering angle and/or the thereto connected, adjusted wheel steering angle, the vehicle longitudinal speed and the vehicle lateral acceleration.

According to one preferred variant of the method, the frictional coefficient for at least one wheel relative to the ground is estimated, especially relative to the roadway and/or a variable characterizing the roadway condition. As is known, the force transfer between the vehicle tires and the road is limited by the frictional conditions at the areas of contact between the tires and the roadway. The maximum transferable longitudinal force in this case is proportional to the normal force. The proportionality factor is referred to as coefficient of adhesion, frictional coefficient or frictional value. The wheel brake pressure information and the wheel speed information can also be used for determining and evaluating the frictional coefficient between vehicle wheel and roadway surface, wherein speed sensors, in particular one for each wheel, can be provided for determining the wheel speed information.

It is particularly advantageous if the frictional coefficient for each individual wheel is estimated. By estimating the frictional coefficient for each wheel, these estimated coefficients can be taken into consideration for determining the intervention in the vehicle movement dynamics. As a result, the intervention into the vehicle movement dynamics can be more precise and the vehicle stability can be maintained more securely.

The frictional coefficient is preferably estimated from current state variables of the vehicle. In particular, the determination of the frictional coefficient can include the slip value, the reference value for the wheel acceleration, the actual acceleration of a wheel, the actual movement vector (vehicle state for speed, rotation, and possibly position) and the reference movement vector. The reference movement vector can be determined from the reference value signals, specified in document DE 100 32 179 A1. In addition, the engine torque for each individual wheel can be included into the estimation of the frictional coefficient.

A plausibility test for estimating the frictional coefficients for the individual wheels is advantageously made by estimating an average frictional coefficient and comparing it to the individual frictional coefficients determined for the wheels. For this, the average frictional coefficient is preferably determined from vehicle variables, which are not relative to the individual wheel, for example the vehicle speed and the steering angle.

The object is furthermore solved with a system for stabilizing the movement dynamics of a vehicle, said system comprising a device for determining reference variables for an intervention in the vehicle movement dynamics, wherein a monitoring system is provided, to which the braking pressures for the individual wheels or thereto connected variables are supplied. The monitoring system comprises means for the predictive determination of a change in the yaw rate from the input variables, wherein the change in the yaw rate is supplied to the device for determining reference variables. The supplied variables connected to the braking pressures at the wheels can include, for example, the progress of the braking pressures at the individual wheels. With a system of this type, it is possible to determine whether an unstable situation can be expected even before the unstable situation actually occurs.

If the instability can be expected, then suitable intervention measures can be taken at the brakes and/or the steering and/or the engine torque in order to prevent the unstable situation. The driving behavior of vehicles can be improved with this measure. In contrast to the prior art, it is not necessary to wait for an unstable situation to occur. The device for determining reference variables, for example, determines the braking pressures to be adjusted at the wheels in order to avoid an unstable driving situation. The device for determining reference variables can furthermore be used to determine a reference steering angle, which must be adjusted to avoid this unstable driving situation, wherein this device can also be embodied as regulating device for regulating the yaw moment of the vehicle. The device can be supplied with actual variables for this, for example the actual braking pressures or the steering angle, which can then be compared to the reference variables.

The yaw moment regulation utilizes variables such as the estimated and expected and/or the actual yaw rate, as well as the estimated and expected and/or the actual change in the yaw rate. The yaw moment regulation determines an additional torque that is necessary to avoid an unstable situation, so that an additional yaw moment is realized by individually activating the brakes and/or the steering.

It is particularly advantageous if the system comprises a device for estimating the frictional coefficient of the tires. If the frictional coefficient for the individual tires is estimated relative to the ground, particularly the roadway, a more precise computation of the vehicle rotation, meaning the yaw rate, is possible. As a result, a more precise regulation of the vehicle stability is possible as well.

The frictional coefficient estimation device is advantageously connected to the monitoring system, so that the estimated frictional coefficients can be taken into consideration for determining the change in the yaw rate.

For one preferred embodiment, the frictional coefficient estimation device is supplied with state variables for the vehicle, a reference value for the movement vector, and an actual movement vector. With this, the frictional coefficient is continuously determined from the variables for the actual wheel acceleration/the actual wheel delay, the reference wheel acceleration/the reference wheel delay, the wheel slip, the engine torque at the individual wheel, and the like.

It is particularly advantageous if the monitoring system is connected to the ABS system. As a result of this measure, the pressures monitored in the ABS system and the determined pressure progress can be used directly in the monitoring system.

Additional features and advantages of the invention can be found in the following description of exemplary embodiments of the invention, with the aid of the Figures in the drawing, which show essential details of the invention, and in the claims. The individual features can be realized for a variant of the invention, either individually or together in any optional combination.

One exemplary embodiment is shown in the schematic drawing and is explained further in the following description, showing in:

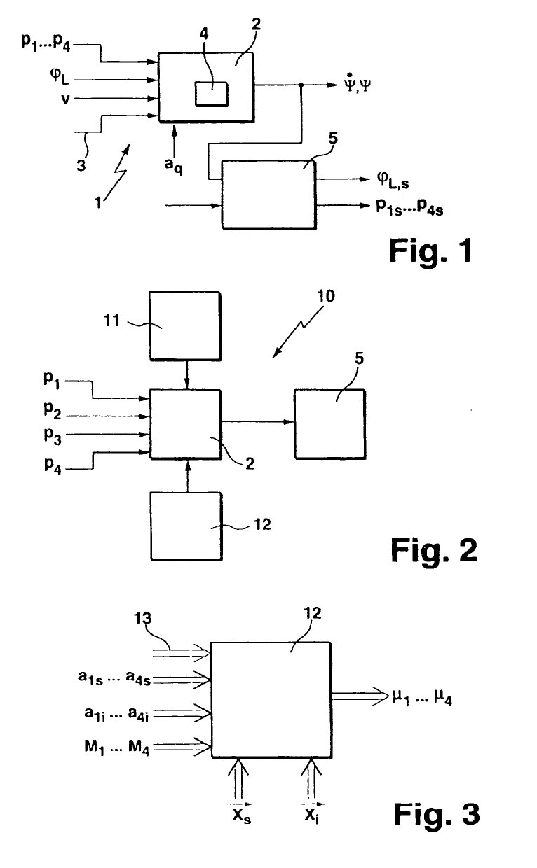

FIG. 1 A first exemplary embodiment of a system for stabilizing the movement dynamics of a vehicle;

FIG. 2 A second embodiment of a system for stabilizing the movement dynamics of a vehicle with a device for estimating the frictional coefficient; and

FIG. 3 A representation of a device for estimating the frictional coefficient.

FIG. 1 shows a system 1 for stabilizing the movement dynamics of a vehicle. The system comprises a monitoring system 2 to which are supplied the braking pressures p₁ to p₄ for the wheels of a vehicle. The monitoring system 2 is furthermore supplied with the steering angle φ_{L} and the vehicle speed v. In addition, the monitoring system 2 is provided with the vehicle lateral acceleration a_{q} as input variable, wherein corresponding sensors are installed in the vehicle for measuring these variables. Arrow 3 indicates that additional vehicle variables can also be provided to the monitoring system 2. The monitoring system 2 is provided with means 4 for the predictive determination of the yaw rate ψ and the change in the yaw rate ψ. The change in the yaw rate ψ and the yaw rate ψ are supplied to a device 5 for determining reference variables for an intervention in the vehicle movement dynamics. The device 5 determines a reference yaw rate, using the output variables of a reference steering angle (φ_{L,s} and the reference braking pressures p₁ₛ to p₄ₛ for adjusting the yaw rate. In this way, the device 5 can regulate the reference values.

FIG. 2 shows a different embodiment of a system 10 for stabilizing the vehicle movement dynamics. The monitoring system 2 is connected to the anti-lock braking system (ABS), the system 11, so that the monitoring system 2 is fed the reference values for the braking pressures at the wheel brakes, which are specified by the ABS system 11. The actual pressures p₁ to p₄ that exist at the wheel brakes are also supplied. The frictional coefficients, which are determined in a frictional-coefficient estimation device 12, are also fed into the monitoring system 2 as additional input variable. These values are also used for the predictive determination of the yaw rate and the change in the yaw rate, which are transmitted to the device 5.

The frictional coefficient estimation device 12 is shown in FIG. 3, wherein arrow 13 indicates that information on the slip value for the individual wheels is supplied to the frictional coefficient estimation device 12. The frictional coefficient estimation device 12 is furthermore supplied with the reference wheel acceleration/the reference wheel delay α₁ₛ to α₄ₛ for each individual wheel and the actual wheel acceleration/wheel delay α₁ᵢ to α₄ᵢ for each individual wheel. The engine torque M1 to M4 on each individual wheel can furthermore be supplied to the frictional coefficient estimation device 12. In addition, the reference movement vector Xₛ and the actual movement vector Xᵢ are also entered into the determination and/or the estimation of the frictional coefficients. The estimated frictional coefficients μ₁ to μ₄ are specified as starting values for each individual wheel.

1. A method for the predictive determination of the change in the yaw rate (ψ) of a vehicle,
characterized in that
the progress of the build-up of the braking pressures (p₁ to p₄) on the wheel brakes is monitored and that the yaw rate (ψ) of the vehicle is determined predictably before a rotation of the vehicle around its vertical axis occurs.

2. The method according to claim 1,
characterized in that
an intervention in the vehicle movement dynamics is determined with the aid of the change in the yaw rate (ψ).

3. The method according to claim 1,
characterized in that
additional state variables of the vehicle are taken into consideration when computing the change in the yaw rate (ψ).

4. The method according to claim 1,
characterized in that
the frictional coefficient (μ₁ to μ₄) is estimated for at least one wheel relative to the ground.

5. The method according to claim 4,
characterized in that
the frictional coefficient (μ₁ to μ₄) is estimated for each individual wheel.

6. The method according to claim 4,
characterized in that
the frictional coefficient (μ₁ to μ₄) is estimated from the actual state variables of the vehicle.

7. The method according to claim 6,
characterized in that
an average frictional coefficient is estimated.

8. The method according to claim 4,
characterized in that
the frictional coefficient or coefficients (μ₁ to μ₄) is or are taken into consideration for determining the intervention in the vehicle movement dynamics.

9. A system (1, 10) for stabilizing the vehicle movement dynamics of a vehicle, comprising a device (5) for determining reference variables for an intervention in the vehicle movement dynamics,
characterized in that
a monitoring system (2) is provided, to which the braking pressures (p₁ to p₄) at the wheels and a variable connected thereto are supplied, and which comprises means (4) for the predictive determination of a change in the yaw rate (ψ) from the input variables, wherein the change in the yaw rate (ψ) is supplied to the device (5) for determining the reference variables.

10. The system according to claim 9,
characterized in that
the system (1, 10) is provided with a frictional coefficient estimation device (12).

11. The system according to claim 10,
characterized in that
the frictional coefficient estimation device (12) is connected to the monitoring system (2).

12. The system according to claim 10,
characterized in that
the frictional coefficient estimation device (12) is supplied with vehicle state variables, a reference movement vector (Xₛ) and an actual movement vector(Xᵢ).

13. The system according to claim 9,
characterized in that
the monitoring system (2) is connected to an anti-lock braking system (11).
